(19) United States
(12) Patent Application Publication
(10) Pub. No.: US 2016/0094876 A1
(43) Pub. Date: Mar. 31, 2016

(54) METHODS AND APPARATUS TO SELECTIVELY REPORT MEDIA DETECTIONS IN REAL-TIME

(71) Applicant: The Nielsen Company (US), LLC, Schaumburg, IL (US)

(72) Inventors: Daniel Nelson, Tampa, FL (US); Arun Ramaswamy, Tampa, FL (US)

(21) Appl. No.: 14/500,336

(22) Filed: Sep. 29, 2014

(51) Int. Cl. H04N 21/442; H04N 21/845; H04N 21/44; H04N 21/437; H04N 21/25

(52) U.S. Cl. CPC H04N 21/44204; H04N 21/44218; H04N 21/437; H04N 21/252; H04N 21/44008; H04N 21/8455

(57) ABSTRACT

Methods and apparatus to selectively report media detections in real-time are disclosed. An example apparatus includes memory to store a media identifier corresponding to media designated for real-time reporting; a detector to obtain media identifying information from a presentation generated by a media presentation device at a presentation time; and a reporter to, when (1) the obtained media identifying information corresponds to the stored media identifier and (2) the presentation time indicates that the presentation is live, convey a detection indication to a collection facility without delay, and when (1) the obtained media identifying information does not correspond to the stored media identifier or (2) the presentation time indicates that the presentation is not live, designate the detection indication for a delayed conveyance to the collection facility.

### FIELD OF THE DISCLOSURE

This disclosure relates generally to audience measurement and, more particularly, to methods and apparatus to selectively report media detections in real-time.

### BACKGROUND

Audience measurement of media (e.g., content and/or advertisements, such as broadcast television and/or radio programs and/or advertisements, streaming media, stored audio and/or video programs and/or advertisements played back from a memory such as a digital video recorder or a digital video disc, audio and/or video programs and/or advertisements played via the Internet, video games, etc.) often involves collection of media identifying data (e.g., signature(s), fingerprint(s), code(s), channel information, time of presentation information, etc.) and people data (e.g., user identifiers, demographic data associated with audience members, etc.). The media identifying data and the people data can be combined to generate, for example, media exposure data indicative of amount(s) and/or type(s) of people that were exposed to specific piece(s) of media.

### BRIEF DESCRIPTION OF THE DRAWINGS

FIG. 1 is a block diagram of an example environment in which an example media monitoring system including an example meter constructed in accordance with teachings of this disclosure is deployed.

FIG. 2 is a block diagram of an example implementation of the example meter of FIG. 1.

FIG. 3 illustrates an example data package provided to the example reporter of FIG. 2 by the example time stamper of FIG. 2.

FIG. 4 is a block diagram of an example implementation of the example reporter of FIG. 2.

FIG. 5 is a flowchart representative of example machine readable instructions that may be executed to implement the example meter of FIGS. 1 and/or 2.

FIG. 6 is a flowchart representative of example machine readable instructions that may be executed to implement the example reporter of FIGS. 2 and/or 3.

FIG. 7 is a block diagram of an example processing system implementing the meter of FIGS. 1, 2 and/or 4 by executing the example machine readable instructions of FIG. 5 and/or the example machine readable instructions of FIG. 6.

### DETAILED DESCRIPTION

Audience measurement systems collect data associated with media exposure environments such as, for example, a television room, a family room, a living room, a bar, a restaurant, an office space, a cafeteria, etc. For example, an audience measurement system may collect media identifying information from media presentations being played in the media environment. Additionally or alternatively, the audience measurement system may collect people data identifying persons in the environment. For example, the audience measurement system may obtain a series of images of the environment and analyzing the images to determine, for example, an identity of one or more persons present in the media exposure environment, an amount of people present in the media exposure environment during one or more times and/or periods of time, an amount of attention being paid to a media presentation by one or more persons, a gesture made by a person in the media exposure environment, etc.

In some examples, the people data is correlated with the media identifying information corresponding to detected media to provide exposure data for that media. For example, an audience measurement entity (e.g., The Nielsen Company (US), LLC) can calculate ratings for a first piece of media (e.g., a television program) by analyzing exposure data collected from a plurality of panelist sites to project the demographics and/or size of an overall audience. For example, in each panelist site wherein the first piece of media is detected in the monitored environment at a first time, media identifying information for the first piece of media is correlated with presence information detected in the environment at the first time and conveyed to a data collection facility. The results from multiple panelist sites are combined and/or analyzed (e.g., by an entity associated with the data collection facility) to provide ratings representative of exposure of an audience (e.g., an entire population, a demographic segment, etc.) to the media.

In some circumstances, entities (e.g., advertisers, media providers, manufacturers, etc.) may desire real-time access to the collected information. That is, in some circumstances real-time ratings may be desired. However, real-time reporting in a media monitoring system collects large amounts of data quite frequently. As a result, real-time reporting quickly depletes computing resources (e.g., uses processing capabilities, depletes available bandwidth, etc.). For example, media identifying information and/or people data are collected every two seconds in some systems. This represents an almost constant generation of exposure information. Real-time transmission of such large amounts of data quickly depletes, for example, computing resources (e.g., central processing unit (CPU) cycles, network interface capacity, etc.) and/or network resources (e.g., bandwidth). Depletion of such resources leads to errors, down time, inaccuracies, and/or additional problems. Such technical problems may prevent generation of real-time ratings data and/or may create the impression that such ratings data is unreliable. Moreover, heavy usage of the bandwidth available for a panelist site may interfere with the panelist media experience by, for example, slowing and/or preventing timely streaming of media.

Due to the technical challenges involved in reporting media monitoring information in real-time, many known systems store the collected information at the panelist site (e.g., in memory of a meter), batch the collected information, and convey the batched information at a time of day typically associated with low network traffic (e.g., two o'clock in the morning). Batching the information reduces the number of transmissions. Delaying the transmission of the data frees up network resources during high-demand times of day (e.g., seven o'clock in the evening). However, this reporting technique introduces delay between the time of data collection and the time of receipt by the data collection facility (and, thus, time of delivery of ratings data based on the collected data to customers of the entity associated with the data collection facility).

Examples methods, apparatus, and articles of manufacture disclosed herein provide selective real-time reporting of media detection information in a manner that overcomes the technical problems caused by overloading or overburdening a networked computing system. Examples disclosed herein enable entities to inform a media measurement entity that deploys media monitoring equipment at monitoring sites that real-time media information is desired for a particular piece of media or for a particular event, such as a broadcast of a championship sports competition. For example, using examples disclosed herein, a media provider or advertiser) informs the audience measurement entity (e.g., The Nielsen Company, LLC) that live or real-time media information (e.g., ratings) are desired such that, for example, customized advertisements can be selected based on the media information and/or rates for advertising can be selected on a real-time basis. Real-time media information may be desired for additional or alternative purposes.

Upon obtaining identification of (a) which piece(s) of media and/or (b) which event(s) for which real-time media information is to be provided, examples disclosed herein facilitate configuration of the media monitoring equipment to report media information associated with the identified (a) piece(s) of media and/or (b) event(s) without delay (e.g., in real-time). Reporting data “without delay” or “in real-time” includes reporting the data immediately (e.g., as quickly as possible subject to processing and/or transmission limitations) as opposed to, for example, storing the data for reporting at a later time with other data. In some examples disclosed herein, one or more conditions are set for the real-time reporting to occur. For example, examples disclosed herein determine whether the piece(s) of media and/or event(s) designated for real-time reporting is/are currently being presented at the monitored sites at a substantially similar (e.g., within a threshold) time as the piece(s) of media and/or event(s) designated for real-time reporting are being provided to the monitored sites. Therefore, such examples determine whether the piece(s) of media and/or event(s) designated for real-time reporting is/are being presented live and/or substantially live at the monitoring sites. A live and/or substantially live presentation is one that is presented within a threshold amount of time after the presentation is provided to (e.g., broadcast to) a site as opposed to being presented later via a time-shifting device (e.g., a digital video recorder (DVR)). Additional or alternative conditions for the real-time reporting are possible.

Examples disclosed herein evaluate the collected information to determine whether the collected information is to be reported with delay or without delay. In some examples, reporting the collected information with delay includes designated the collection information for storage, batching with other collected information, and delayed conveyance as batched to, for example, the data collection facility. In some examples, reporting the collected information without delay includes immediately (e.g., as quickly as possible depending on system capabilities) conveying an individual data package associated with an individual piece of collected media identifying information.

Accordingly, examples disclosed herein provide real-time reporting of media information without overburdening a networked computing system supporting the collection, processing and/or delivery of such information. For example, the selective real-time reporting of examples disclosed herein intelligently applies to particular media information that will be acted upon (e.g., by media providers that ordered the real-time reporting) immediately, but does not apply to other media information that will not be acted upon immediately (e.g., does not apply to media that will be aggregated and analyzed at a time significantly later than a broadcast time of the corresponding media). As such, examples disclosed herein avoid imposing the resource depletion of real-time reporting when the corresponding information will not be used in real-time. Further, with advanced knowledge of particular periods of time during which real-time reporting will occur, the media monitoring entity may adjust (e.g., increase) resources for those particular periods of time to meet the increased demand, thereby reducing a likelihood of the system experiencing problems and/or issues.

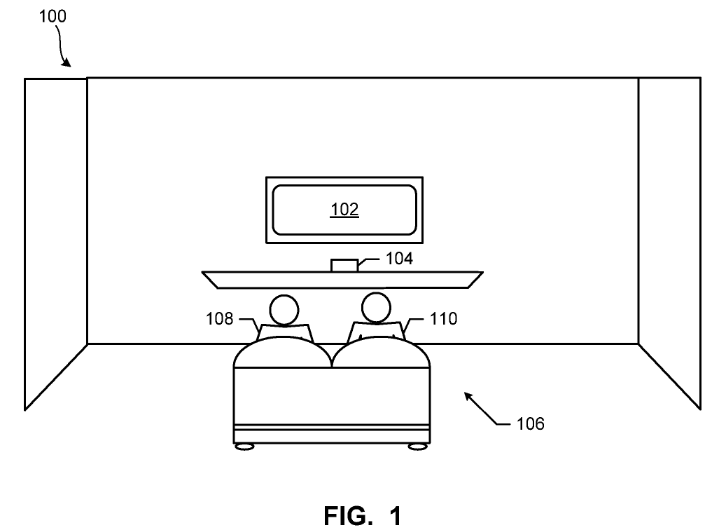

FIG. 1 is an illustration of an example media exposure environment 100 including an information presentation device 102, an example meter 104 constructed in accordance with teachings of this disclosure, and an audience 106 including a first person 108 and a second person 110. In the illustrated example of FIG. 1, the information presentation device 102 is a television and the media exposure environment 100 is a room of a household (e.g., a room in a home of a panelist such as the home of a “Nielsen family”) that has been statistically selected to develop television ratings data for population(s)/demographic(s) of interest. In the illustrated example of FIG. 1, one or more persons of the household have registered with an audience measurement entity (e.g., by agreeing to be a panelist) and have provided demographic information to the audience measurement entity as part of a registration process to enable associating demographics with viewing activities (e.g., media exposure). The example meter 104 of FIG. 1 can be implemented in additional and/or alternative types of environments such as, for example, a room in a non-statistically selected household, a theater, a restaurant, a tavern, a retail location, an arena, etc. In some examples, the example meter 104 of FIG. 1 is implemented, at least in part, in connection with additional and/or alternative types of media presentation devices such as, for example, a radio, a computer, a tablet (e.g., an iPad®), a cellular telephone, and/or any other communication device able to present media to one or more individuals.

In some examples, the meter 104 of FIG. 1 is implemented by software installed in consumer electronics associated with the environment 100 such as, for example, a set-top box, a BluRay disc player, and/or a video game system (e.g., an XBOX® having a Kinect® sensor). In such instances, the example meter 104 of FIG. 1 is, for example, downloaded from a network, installed at the time of manufacture, installed via a port (e.g., a universal serial bus (USB) port receiving a jump drive provided by the audience measurement company), installed from a storage disc (e.g., an optical disc such as a BluRay disc, Digital Versatile Disc (DVD) or CD (compact Disk)), and/or any other suitable manner of installation. Executing the meter 104 on equipment associated with (e.g., owned by) one or more panelists is advantageous in that costs of installation are reduced by relieving the audience measurement entity of the need to supply hardware to the monitored household. In some examples, the meter 104 is integrated with the consumer electronics (e.g., by the manufacturer prior to sale to the consumer). That is, in some examples, the consumer electronics into which the meter 104 is integrated may be repurposed (and/or data collected by the consumer electronics may be repurposed) for audience measurement. For example, the meter 104 may utilize one or more sensors of a video game system to collect, for example, image data from the environment 100.

In some examples, rather than installing the meter 104 on the consumer electronics of the panelist(s), the example meter 104 of FIG. 1 is a dedicated audience measurement unit provided by the audience measurement entity. In such examples, the meter 104 may include its own housing, processor, memory and software to perform the desired audience measurement functions. In some examples, the dedicated meter 104 is adapted to communicate with (e.g., via a wired and/or wireless connection), for example, information capturing devices implemented in the environment 100 such as, for example, a video game system having image capturing equipment and/or audio capturing equipment. In some examples, the communications are effected via the consumer electronics of the panelist (e.g., via a video game console). In some examples, the meter 104 includes information collection device(s), such as an image capturing device and/or audio sensors and, thus, no direct interaction (outside of monitoring outputs) with the consumer electronics owned by the panelist is involved.

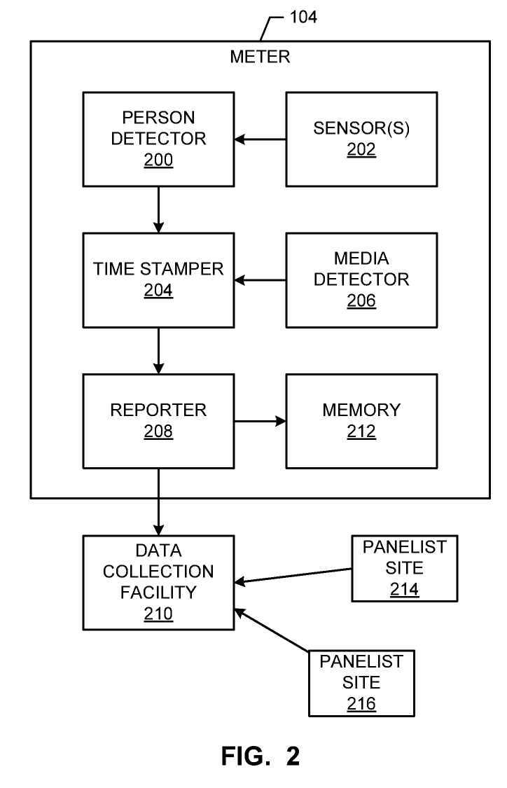

As disclosed below in connection with FIGS. 2-6, the example meter 104 of FIG. 1 selectively reports collected information (e.g., data representative of media being presented in the environment 100 and/or data representative of the audience 106) in real-time to, for example, a data collection facility associated with the audience measurement entity that deployed the meter 104 in the environment 100.

FIG. 2 illustrates an example implementation of the meter 104 of FIG. 1. The example meter 104 of FIG. 2 includes a person detector 200 to detect one or more persons in, for example, the media exposure environment 100 of FIG. 1. The example person detector 200 uses any suitable person detection technique to determine, for example, a number of people in the environment 100, identities of individuals in the environment 100, etc. To provide the person detector 200 with data on which the people detections can be developed, the example meter 104 of FIG. 2 includes one or more sensor(s) 202 such as, for example, an image capturing device (e.g., an infrared imager, a complimentary metal-oxide semiconductor (CMOS) camera, and/or a charge coupled device (CCD) camera) to capture two-dimensional image data representative of the media exposure environment 100, a depth sensor (e.g., a Kinect® sensor) to capture three-dimensional data representative of the media exposure environment 100, an audio sensor (e.g., a microphone) to capture audio data representative of sounds in the media exposure environment 100, and/or direct inputs (e.g., buttons and/or touch screen) to be engaged by person in the environment 100 to indicate their presence. In some examples, the sensor(s) 202 only capture data when the information presentation device 102 is in an “on” state and/or when the meter 104 determines that media is being presented in the environment 100 of FIG. 1.

The example person detector 200 of FIG. 2 outputs, for example, calculated people counts or tallies and/or other people data (e.g., identity information) to a time stamper 204 of the example meter 104 of FIG. 2. The example time stamper 204 of the illustrated example includes a clock and a calendar. The example time stamper 204 of FIG. 2 associates a time period (e.g., 1:00 a.m. Central Standard Time (CST) to 1:01 a.m. CST) and date (e.g., Jan. 1, 2014) with each piece of information received from the person detector 200 by, for example, appending the period of time and date information to an end of the people data. In some examples, the time stamper 204 applies a single time and date rather than a period of time.

The example time stamper 204 of FIG. 2 also receives data from an example media detector 206 of the example meter 104. The example media detector 206 of FIG. 2 detects presentation(s) of media in the media exposure environment 100 of FIG. 1 and/or collects identification information associated with the detected presentation(s). For example, the media detector 206 of FIG. 2, which may be in wired and/or wireless communication with the information presentation device 102 (e.g., a television), a video game system deployed in the environment 100, an STB associated with the information presentation device 102, and/or any other component of FIG. 1, can identify a presentation time and/or a source of a presentation. The presentation time and the source identification data (e.g., channel identification data) may be utilized to identify the program by, for example, cross-referencing a program guide configured, for example, as a look up table. In such instances, the source identification data is, for example, the identity of a channel (e.g., obtained by monitoring a tuner of an STB or a digital selection made via a remote control signal) currently being presented on the information presentation device 102.

Additionally or alternatively, the example media detector 206 of FIG. 2 can identify the presentation by detecting codes and/or watermarks embedded with or otherwise conveyed (e.g., broadcast) with media being presented via an STB and/or the information presentation device 102. As used herein, a code is an identifier that is transmitted with and/or otherwise associated with media for the purpose of identifying (e.g., an audience measurement code) the media and/or a source of the media and/or for the purpose of tuning to (e.g., a packet identifier (PID) header and/or other data used to tune or select packets in a multiplexed stream of packets) the corresponding media. Codes may be carried in the audio, in the video, in metadata, in a vertical blanking interval, in a program guide, in content data, or in any other portion of the media and/or the signal carrying the media. In the illustrated example of FIG. 2, the media detector 206 extracts the code(s) from the media. In some examples, the media detector 206 may collect samples of the media and export the samples to a remote site for detection of the code(s).

In the illustrated example, codes detected by the media detector 206 include live time data indicative of, for example, a date and time at which the corresponding media is broadcast and/or otherwise provided (e.g., multi-cast) to one or more information presentation devices. For example, a code detected by the example media detector 206 having live time data of Jan. 1, 2014, at 7:00 pm EST indicates that the corresponding media is to be conveyed (e.g., broadcast) by a media distributor at that time on that day. Thus, if this example code were detected in the environment 100 by the media detector 206 within a threshold amount of time (e.g., thirty seconds) of 7:00 pm EST on Jan. 1, 2014, the presentation of the media is considered to be a live presentation in the example media exposure environment 100 of FIG. 1.

Additionally or alternatively, the example media detector 206 of FIG. 2 can collect a signature to identify the media. As used herein, a signature is a representation of a characteristic of the signal carrying or representing one or more aspects of the media (e.g., a frequency spectrum of an audio signal). Signatures may be thought of as fingerprints of the media. Collected signature(s) can be compared against a collection of reference signatures of known media (e.g., content and/or advertisements) to identify tuned media. In some examples, the signature(s) are generated by the media detector 206. Additionally or alternatively, the example media detector 206 of FIG. 2 collects samples of the media and exports the samples to a remote site for generation of the signature(s).

In the example of FIG. 2, the media detector 206 conveys the media identifying information (e.g., a code) to the example time stamper 204, which time stamps the received information. In the illustrated example of FIG. 2, the time stamper 204 appends a time stamp to the received media identifying information to generate a data package including the media identifying information and a time indicative of when the media detector 206 collected the media identifying information from the environment 100.

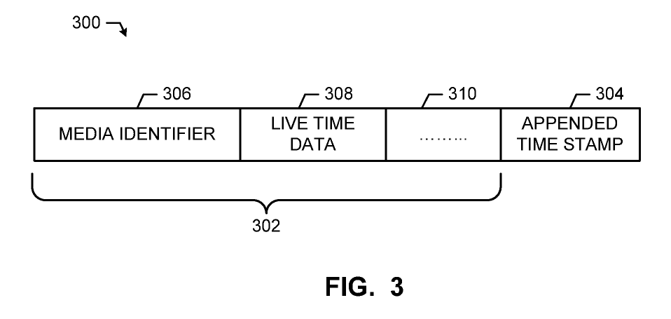

FIG. 3 illustrates an example data package 300 generated by the example time stamper 204 in response to the time stamper 204 receiving media identifying information from the example media detector 206. The example data package 300 of FIG. 3 includes the media identifying information 302 collected from the environment 100 and an appended time stamp 304 indicative of when the media identifying information 302 was collected (e.g., when the information presentation device 102 of FIG. 1 presented the media from which the media identifying information 302 was extracted). In the example of FIG. 3, the media identifying information 302 includes a media identifier 306, live time data 308, and additional payload including any suitable metadata. In the illustrated example, of FIG. 3, the live time data 308 is indicative of a time at which the corresponding piece of media was distributed (e.g., broadcast or multi-cast) or otherwise provided to media presentation devices or systems. Thus, the example data package 300 indicates (1) which particular media is being presented in the environment 100 via the media identifier 306, (2) a time at which that particular media is considered live (e.g., a broadcast time of the media) via the live time data 308, and (3) a time at which the media was detected as being presented in the environment 100 via the appended time stamp 304.

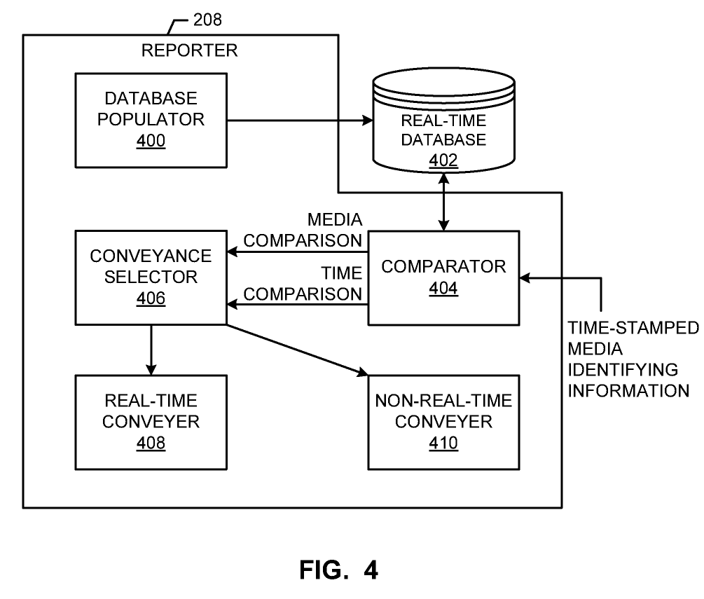

The example time stamper 204 of FIG. 2 provides the example data package 300 of FIG. 3 and the people data generated by the example person detector 200 to an example reporter 208. As disclosed below in connection with FIG. 4, the example reporter 208 determines whether the data package 300 and/or the people data is to be conveyed to an example data collection facility 210 without delay (e.g., in real-time) or with delay (e.g., in non-real-time as part of a batch process). In some examples, the reporter 208 stores copies of the people data and/or the data package 300 in example memory 212 of the meter 104 regardless of whether the information is conveyed with or without delay. Alternatively, the example reporter 208 may store the information in the memory 212 only when the information is to be conveyed to the data collection facility 210 with delay. This latter approach saves memory capacity at the meter 104 and/or the device hosting the meter 104 (e.g., saves capacity of the memory 212 of FIG. 2).

The example memory 212 of FIG. 2 may include a volatile memory (e.g., Synchronous Dynamic Random Access Memory (SDRAM), Dynamic Random Access Memory (DRAM), RAMBUS Dynamic Random Access Memory (RDRAM, etc.) and/or a non-volatile memory (e.g., flash memory). The example memory 212 of FIG. 2 may also include one or more mass storage devices such as, for example, hard drive disk(s), compact disk drive(s), digital versatile disk drive(s), etc. When the example meter 104 is integrated into, for example, a video game system or a STB, the meter 104 may utilize memory of the video game system or the set-top box to store information such as, for example, the people counts, the image data, etc. Saving memory in such examples has increased importance as it avoids and/or reduces the likelihood of interfering with the native operation (e.g., game play) of the host device.

To convey data to the example data collection facility 210, the example reporter 208 of FIG. 2 utilizes a network (e.g., a local-area network, a wide-area network, a metropolitan-area network, the Internet, a digital subscriber line (DSL) network, a cable network, a power line network, a wireless communication network, a wireless mobile phone network, a Wi-Fi network, etc.). In some examples, the example reporter 208 utilizes the communication capabilities (e.g., network connections) of a video game system and/or a STB to convey information to, for example, the data collection facility 210. In the illustrated example of FIG. 2, the data collection facility 210 is managed and/or owned by an audience measurement entity (e.g., The Nielsen Company (US), LLC). The audience measurement entity associated with the example data collection facility 210 of FIG. 2 utilizes the media identifying data collected by the media detector 206 and/or the people data generated by the person detector 200 to generate exposure information. The information from many panelist locations may be collected and analyzed to generate ratings (e.g., in real-time or non-real-time) representative of media exposure by one or more populations of interest. In the illustrated example of FIG. 2, the data collection facility 210 receives information from other panelist sites 214, 216 in addition to the example environment 100 of FIG. 1. Accordingly, the example audience measurement entity associated with the example data collection facility 210 can centrally control collection of real-time data from any panelist site and/or any suitable combination or subset of panelist sites (e.g., a subset of the environment 100 and the panelist sites 214, 216 selected according to, for example, demographic information and/or psychographic information associated with respective households and/or household member(s)).

While an example manner of implementing the meter 104 of FIG. 1 is illustrated in FIG. 2, one or more of the elements, processes and/or devices illustrated in FIG. 2 may be combined, divided, re-arranged, omitted, eliminated and/or implemented in any other way. Further, the example person detector 200, the example time stamper 204, the example media detector 206, the example reporter 208 and/or, more generally, the example meter 104 of FIG. 2 may be implemented by hardware, software, firmware and/or any combination of hardware, software and/or firmware. Thus, for example, any of the example person detector 200, the example time stamper 204, the example media detector 206, the example reporter 208 and/or, more generally, the example meter 104 of FIG. 2 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, person detector 200, the example time stamper 204, the example media detector 206, the example reporter 208 and/or, more generally, the example meter 104 of FIG. 2 is/are hereby expressly defined to include a tangible computer readable storage device or storage disk such as a memory, a digital versatile disk (DVD), a compact disk (CD), a Blu-ray disk, etc. storing the software and/or firmware. Further still, the example meter 104 of FIG. 1 may include one or more elements, processes and/or devices in addition to, or instead of, those illustrated in FIG. 2, and/or may include more than one of any or all of the illustrated elements, processes and devices.

FIG. 4 illustrates an example implementation of the example reporter 208 of FIG. 2. The example reporter 208 of FIG. 4 is initialized in response to, for example, the information presentation device 102 being placed in an ON state. The example reporter 208 of FIG. 4 includes a database populator 400 to populate and/or update a real-time database 402. In the illustrated example, the real-time database 402 is implemented via, for example, the example memory 212 of FIG. 2. The example real-time database 402 includes one or more media identifiers corresponding to media for which real-time reporting has been enabled. For example, a media distributor associated with a championship sports event (e.g., the Super Bowl) may desire real-time ratings for the event. When the media distributor orders or commissions the real-time ratings from, for example, the audience measurement entity associated with the data collection facility 210 of FIG. 2, the example database populator 400 of FIG. 4 receives one or more media identifiers corresponding to the event. The example database populator 400 of FIG. 4 adds the received media identifier(s) to the real-time database 402. Thus, the audience measurement entity associated with the data collection facility 210 of FIG. 2 can remotely control the reporter 208 to return data from real-time ratings by including one or more media identifiers associated with media for which real-time reporting has been ordered or commissioned in the example real-time database 402. As the audience measurement entity associated the data collection facility 210 of FIG. 2 is in communication with a plurality of panelist sites, the example reporter 208 of FIG. 2 at one or more of the panelist sites can be centrally controlled by, for example, the audience measurement entity to provide real-time data. For example, a particular subset of the panelist sites may be selected (e.g., based on demographics) for conveyance of real-time data to be used in generation of real-time ratings. Further, the audience measurement entity associated with the data collection facility 210 of FIG. 2 process the real-time data to, for example, generate real-time ratings and to provide the real-time ratings to one or more entities (e.g., any entity that commissioned the real-time ratings for a particular event or media). In some examples, the audience measurement entity associated with the data collection facility 210 charges a fee or premium for the real-time reporting.

The example reporter 208 of FIG. 4 includes a comparator 404 to determine (1) whether media detected in the environment 100 corresponds to any of the media identifier(s) in the real-time database 402 and (2) whether the media is being presented live. The example comparator 404 of FIG. 4 receives time stamped media identifying information indicative of media detected in the environment 100 and a time at which the media was detected in the environment 100. For example, the comparator 404 of FIG. 4 receives the example data package 300 of FIG. 3. The example comparator 404 of FIG. 4 compares the media identifier 306 of the example data package 300 to the media identifier(s) of the real-time database 402. That is, the example comparator 404 determines whether the detected media presented in the environment 100 corresponds to any media of the real-time database 402 for which real-time reporting has been enabled. Further, the example comparator 404 of FIG. 4 compares the live time data 308 of the example data package 300 to the appended time stamp 304 of the example data package 300. That is, the example comparator 404 determines whether the time at which the code 306 was detected corresponds to the time at which the media from which the code 306 was detected was provided to the information presentation device 102 (e.g., within a threshold amount of time, such as thirty seconds to account for transmission delays and/or moderate pause amounts).

In the illustrated example of FIG. 4, results of the comparisons performed by the comparator 404 are conveyed to a conveyance selector 406. The example conveyance selector 406 determines whether one or more conditions are met. While any suitable conditions may additionally or alternatively be set by the example reporter 208, the example conditions tested by the example conveyance selector 406 of FIG. 4 correspond to the comparisons described above performed by the example comparator 404. In particular, the example conveyance selector 406 of FIG. 4 determines whether both comparisons described above evaluate to true (e.g., that (1) the media detected in the environment 100 does correspond to one of the media identifiers of the real-time database 402 and (2) that the media is being presented live (e.g., at a substantially similar (e.g., within a threshold amount of time) time as when the media is provided to the information presentation device 102 by, for example, a content distributor)). In the illustrated example of FIG. 4, the conveyance selector 406 selects a real-time conveyer 408 to handle reporting of the data package 300 when both of these conditions are met. In the illustrated example of FIG. 4, the conveyance selector 406 selects a non-real-time conveyer 410 to handle reporting of the data package 300 when one of these conditions is not met. That is, the non-real-time conveyer 410 is selected when either (1) the media identifier 306 of the data package 300 is not found in the real-time database 402 (thereby indicating that the corresponding media has not been identified for real-time ratings) or (2) the live time data 308 of the data package 300 is not within a threshold amount of time of the appended time stamp 304 of the data package 300 (thereby indicating that the media is not being played back in real time and, thus, real-time ratings). Thus, the example reporter 208 provides selective conveyance of real-time data to avoid problems that arise from sending too much data too frequently, such as reduced bandwidth, reduced computing resources, etc.).

In the illustrated example of FIG. 4, the real-time conveyer 408 facilitates immediate (e.g., without delay) transmission of, for example, the data package 300 of FIG. 4 and/or corresponding people data to the example data collection facility 210 of FIG. 2 when the conveyance selector 406 selects the example real-time conveyor 408 of FIG. 4. The example real-time conveyer 408 of FIG. 4 utilizes any suitable equipment, technique(s), and/or resource(s) to facilitate rapid (e.g., real-time) delivery of the information to the example data collection facility 210. In some examples, the real-time conveyer 408 of FIG. 4 reserves network equipment, such as a port associated with a network interface card (e.g., of the meter 104), so that the example real-time conveyer 408 of FIG. 4 does not have to wait for other (e.g., non-real-time enabled data) transmission to complete before being able to convey the real-time information. Additionally or alternatively, when the example meter 104 utilizes more than one communication mechanism and/or protocol (e.g., a wired communication interface and a wireless communication interface), the example real-time conveyer 408 reserves and/or otherwise uses the fastest communication mechanism available to the meter 104. Additionally or alternatively, when the example meter 104 utilizes a queue and/or other ordered collection of transmissions to organize and/or prioritize transmissions, the example real-time conveyer 408 of FIG. 4 places the corresponding transmission(s) at a position of highest priority such that those transmissions are sent before other transmission, even when the other transmission may have been previously scheduled to transmit before the real-time data. In some examples, in addition to facilitating delivery of the data without delay to the data collection facility 210, the example real-time conveyer 408 causes the data to be stored in the memory 212 of the example meter 104 (e.g., as a backup copy).

The example non-real-time conveyer 410 of FIG. 4 facilitates non-real-time conveyance of data when the conveyance selector 406 selects the example non-real-time conveyer 410 of FIG. 4. In the illustrated example of FIG. 4, the non-real-time conveyer 410 designates, for example, the data package 300 and/or the corresponding people data for a delayed (e.g., non-real-time) conveyance to the example data collection facility 210 of FIG. 2. In some examples, the designation placed by the example non-real-time conveyer 410 causes the data to be stored in the memory 212, from which the data is conveyed to the data collection facility 210 with delay. For example, the non-real-time conveyer 410 of FIG. 4 places the data in the memory 212 and schedules the data to be conveyed to the data collection facility at a predetermined time of expected low network traffic, a predetermined low cost transmission time (e.g., when network charges are lower), and/or a predetermined time of expected low activity on the meter 104. The conveyance time scheduled by the example non-real-time conveyer 410 of FIG. 4 may be, for example, two o'clock in the morning. Additionally or alternatively, the example non-real-time conveyer 410 of FIG. 4 causes the data from one detection or measurement taken from the environment 100, such as the data package 300 of FIG. 3, to be batched together with other data from other detection(s) or measurement(s) taken from the environment 100. Batching the data includes, for example, grouping the different pieces of data and compressing the group to a smaller size. The batched data can be unpacked at, for example, the data collection facility 210.

While an example manner of implementing the reporter 208 of FIG. 2 is illustrated in FIG. 4, one or more of the elements, processes and/or devices illustrated in FIG. 4 may be combined, divided, re-arranged, omitted, eliminated and/or implemented in any other way. Further, the example database populator 400, the example comparator 404, the example conveyance selector 406, the example real-time conveyer 408, the example non-real-time conveyer 410 and/or, more generally, the example reporter 208 of FIG. 4 may be implemented by hardware, software, firmware and/or any combination of hardware, software and/or firmware. Thus, for example, any of the example database populator 400, the example comparator 404, the example conveyance selector 406, the example real-time conveyer 408, the example non-real-time conveyer 410 and/or, more generally, the example reporter 208 of FIG. 4 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, database populator 400, the example comparator 404, the example conveyance selector 406, the example real-time conveyer 408, the example non-real-time conveyer 410 and/or, more generally, the example reporter 208 of FIG. 4 is/are hereby expressly defined to include a tangible computer readable storage device or storage disk such as a memory, a digital versatile disk (DVD), a compact disk (CD), a Blu-ray disk, etc. storing the software and/or firmware. Further still, the example reporter 208 of FIG. 2 may include one or more elements, processes and/or devices in addition to, or instead of, those illustrated in FIG. 4, and/or may include more than one of any or all of the illustrated elements, processes and devices.

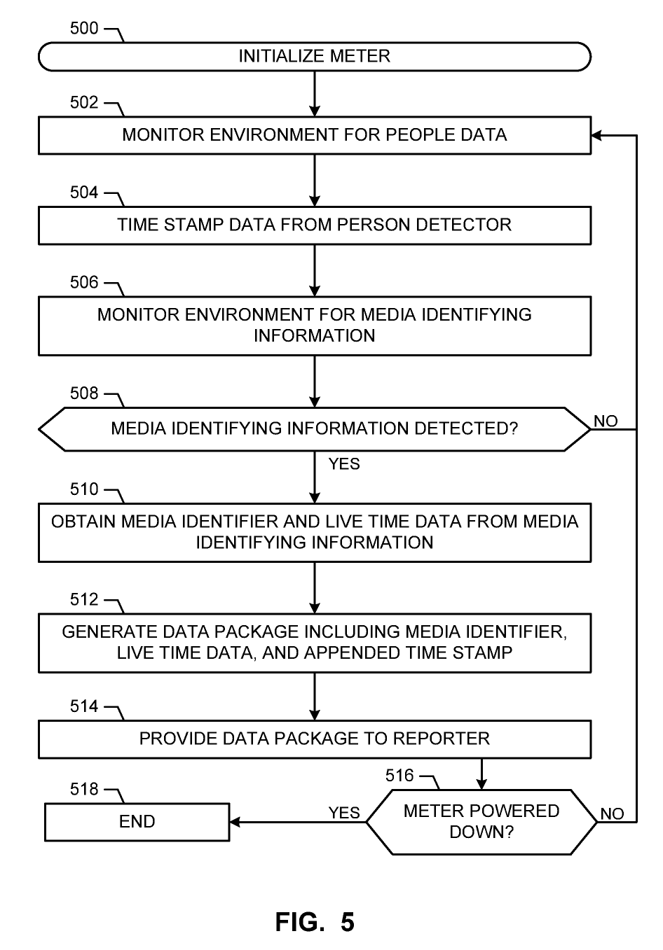

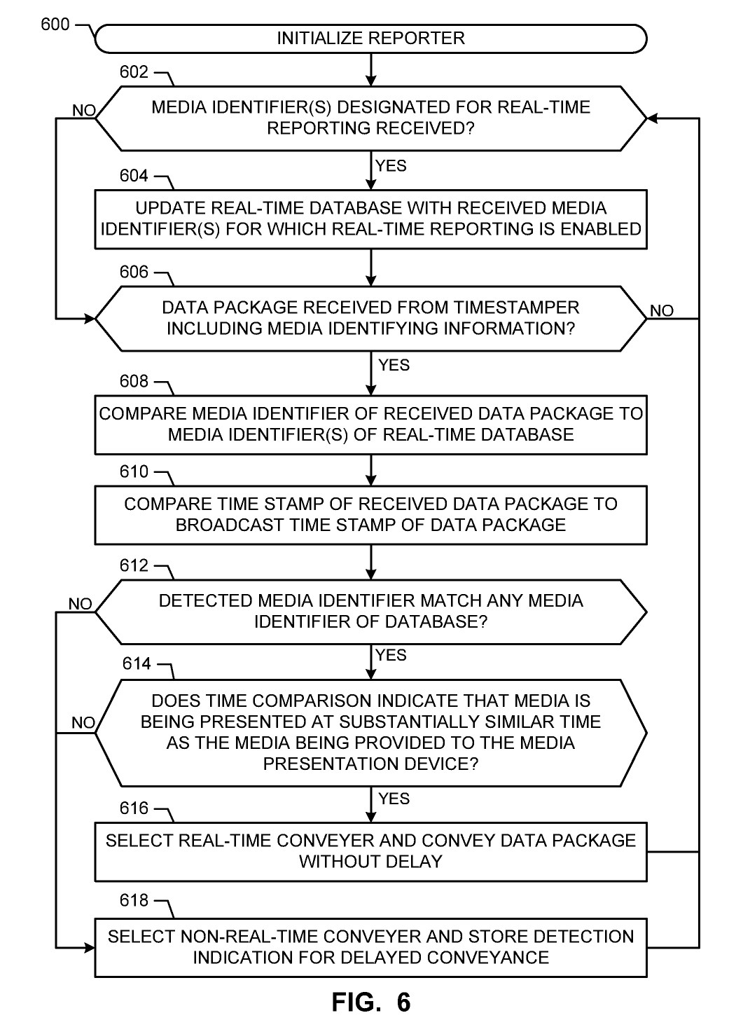

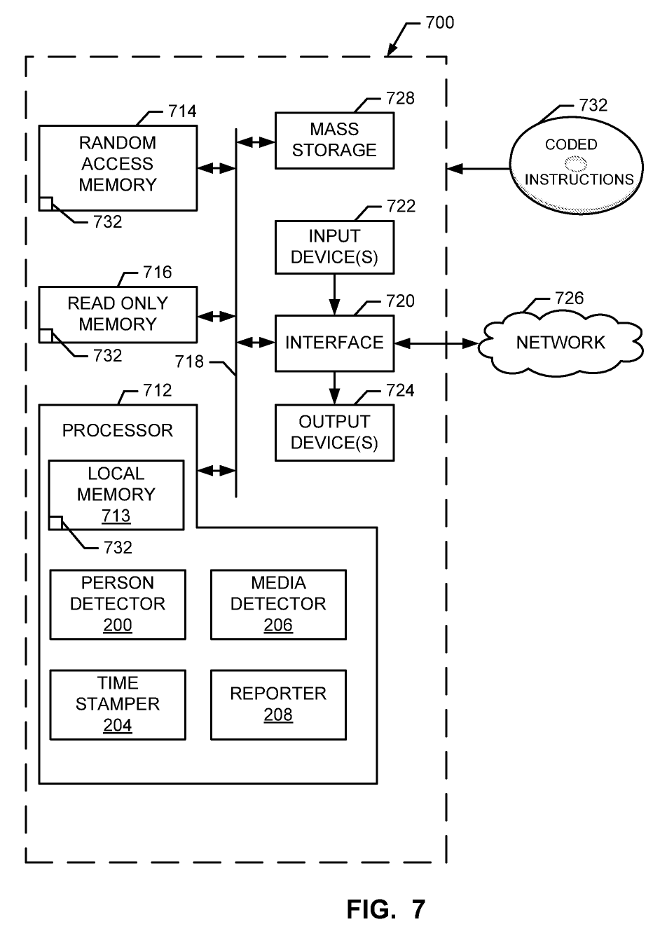

A flowchart representative of example machine readable instructions for implementing the meter 104 of FIGS. 1 and/or 2 is shown in FIG. 5. A flowchart representative of example machine readable instructions for implementing the reporter 208 of FIGS. 2 and/or 4 is shown in FIG. 6. In these examples, the machine readable instructions comprise programs for execution by a processor such as the processor 712 shown in the example consumer electronics device 700 discussed below in connection with FIG. 7. The programs may be embodied in software stored on a tangible computer readable storage medium such as a CD-ROM, a floppy disk, a hard drive, a digital versatile disk (DVD), a Blu-ray disk, or a memory associated with the processor 712, but the entire programs and/or parts thereof could alternatively be executed by a device other than the processor 712 and/or embodied in firmware or dedicated hardware. Further, although the example programs are described with reference to the flowcharts illustrated in FIGS. 5 and 6, many other methods of implementing the example meter 104 and/or the example reporter 208 may alternatively be used. For example, the order of execution of the blocks may be changed, and/or some of the blocks described may be changed, eliminated, or combined.

As mentioned above, the example processes of FIGS. 5 and/or 6 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 5 and/or 6 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The example of FIG. 5 begins with an initialization of the example meter 104 (block 500). In the illustrated example of FIG. 5, the meter 104 is initialized in response to, for example, the information presentation device 102 being placed in an ON state. The initialization of the meter 104 includes, for example, activating the sensor(s) 202 to begin providing information to the example people detector 200 and/or the example media detector 206. The example person detector 200 receives information from the sensor(s) 202 to monitor the environment 100 for one or more persons (block 502). In the illustrated example of FIG. 5, the person detector 200 counts a number of people in the environment 100 and determines, if possible, the identity of the individuals in the environment 100. As an example scenario, the people detector 200 detects that a total of two people are present in the environment 100 and that the two people are the father and mother of the household in which the meter 104 is deployed. As discussed above, the identity of the people also provides demographic information for the audience present in the environment 100. The example person detector 200 provides the people data (e.g., a people count and/or identity information) to the example time stamper 204, which time stamps the information (block 504).

In the example of FIG. 5, the media detector 206 monitors the environment 100 for media being presented via, for example, the information presentation device 102 (block 506). For example, the media detector 206 of FIG. 2 detects media identifying information, such as a code, in audio information collected via the sensor(s) 202. In the example of FIG. 5, if media identifying information is detected in the environment 100 (block 508), the media detector 206 identifies and/or extracts, for example, a media identifier indicative of the particular media being presented by the information presentation device 102, live time data indicative of a time at which the media being presented was provided (e.g., broadcast by a content distributor) to the information presentation device 102 extracted from the detected, and/or any other data found in the payload of the code (block 510). To continue the above example scenario in which the father and the mother were detected in the environment 100, the media identifier corresponds to the Super Bowl and the live time data indicates that the portion of the Super Bowl corresponding to the collected code is broadcast at 6:45 p.m. on Feb. 10, 2014.

In the example of FIG. 5, the information generated and/or extracted by the media detector 206 is conveyed to the time stamper 204, which generates a data package by appending a time stamp to the received information (block 512). In the example of FIG. 5, the example data package 300 of FIG. 3 is generated at block 512. As discussed above, the example data package 300 includes the media identifier 306 indicative of the media being presented, the live time data 308 indicative of a time at which the media is considered live (e.g., presented within a threshold amount of time of a broadcast), and the appended time stamp 304 indicative of when the code was detected in the environment 100 (e.g., when the media was presented by the information presentation device 102 in the environment 100). To continue the above example scenario in which the father and mother were detected in the environment 100, the data package 300 indicates that a portion of the Super Bowl broadcast at 6:45 p.m. on Feb. 10, 2014, was presented in the environment 100 at 6:45 p.m. on Feb. 10, 2014. In the illustrated example of FIG. 5, the time stamper 204 provides the data package 300 to the example reporter 208 (block 514). As described below in connection with FIG. 6, the example reporter 208 determines whether the data package 300 is to be reported to the data collection facility 210 without delay (e.g., in real-time) or with delay (e.g., in non-real-time) and handles conveyance of the data package 300 to the data collection facility 210 accordingly. If the meter 104 is powered down (block 516), the example of FIG. 5 ends (block 518). Otherwise, control returns to block 502.

FIG. 6 begins with an initialization of the example reporter 208 of FIGS. 2 and/or 4 (block 600). In the illustrated example of FIG. 6, the initialization of the reporter 208 coincides with the initialization of the example meter 104. As described above, one or more entities (e.g., a content distributor, an advertiser, etc.) may desire real-time information. Such entities provide the audience measurement entity associated with the data collection facility 210 with media identifying information corresponding to the media for which real-time information is desired. In the illustrated example, the audience measurement entity (that receives real-time orders from entities desiring real-time reporting) provides the corresponding media identifiers to the example database populator 400. In the example of FIG. 6, if such media identifier(s) are received by the example reporter 208 (block 602), the database populator 400 populates and/or updates the real-time database 402 with the received media identifiers (block 604). Thus, the real-time database 402 includes one or more media identifiers corresponding to media for which detections thereof are to be reported without delay by the example meter 104.

As described above in connection with FIG. 5, the media detector 206 provides the reporter 208 with, for example, the data package 300 of FIG. 3. If such a data package 300 is received by the reporter 208 (block 606), the example comparator 404 compares the media identifier 306 of the data package 300 to the media identifier(s) of the real-time database 402 (block 608). That is, the example comparator 404 determines whether the media detected in the environment 100 corresponds media for which real-time reporting has been ordered and/or commissioned via the audience measurement entity associated with the data collection facility 210. Further, the example comparator 404 compares the appended time stamp 304 of the data package 300 to the live time data 308 of the data package 300 (block 610). That is, the example comparator 404 determines whether the media is being presented in the environment 100 in a live or substantially live (e.g., within a threshold amount of time of delivery to the presentation device 102) manner. In the example of FIG. 6, if the media identifier 306 of the data package 300 matches any of the media identifiers of the real-time database 402 (block 612) and the presentation is considered live (e.g., presented at a substantially similar time as the time at which the media is provided to the information presentation device 102) (block 614), the example conveyance selector 406 selects the real-time conveyer 408 to handle transmission of the data package 300 (and the corresponding people data) to, for example, the data collection facility 210 and the example real-time conveyer 408 conveys the data to the data collection facility 210 immediately, without delay (e.g., in real-time) (block 616). Otherwise, in the example of FIG. 6, if either (1) the media identifier detected in the environment 100 does not correspond to any media listed in the real-time database 402 (block 612) or (2) the media is not being presented substantially live (block 614), the example conveyance selector 406 selects the non-real-time conveyer 410 to handle transmission of the data package 300 (and the corresponding people data) to, for example, the data collection facility 210 and the example non-real-time conveyer 410 stores the data in the memory 212 of the meter 104 for delayed conveyance to the data collection facility 210 (block 618). As described above, the stored data package 300 in such instances is batched with other data from other time periods and conveyed the batched data to the data collection with delay (e.g., in non-real-time) at a time later than the time at which the media is provided to the information presentation device 102. Control returns to block 602 in the example of FIG. 6.

FIG. 7 is a block diagram of an example consumer electronics device 700 that has been repurposed to execute the instructions of FIG. 5 to implement the example meter 104 of FIGS. 1 and/or 2 and/or the instructions of FIG. 6 to implement the example reporter 208 of FIGS. 2 and/or 4. The consumer electronics device 700 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The consumer electronics device 700 of the illustrated example includes a processor 712. The processor 712 of the illustrated example is hardware. For example, the processor 712 can be implemented by one or more integrated circuits, logic circuits, microprocessors or controllers from any desired family or manufacturer. In the illustrated example of FIG. 7, the person detector 200, the time stamper 204, the media detector 206 and/or the example reporter 208 are implemented via the example processor 712.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The consumer electronics device 700 of the illustrated example also includes an interface circuit 720. The interface circuit 720 may be implemented by any type of interface standard, such as an Ethernet interface, a universal serial bus (USB), and/or a PCI express interface.

In the illustrated example, one or more input devices 722 are connected to the interface circuit 720. The input device(s) 722 permit(s) a user to enter data and commands into the processor 712. The input device(s) can be implemented by, for example, an audio sensor, a microphone, a camera (still or video), a keyboard, a button, a mouse, a touch screen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display, a cathode ray tube display (CRT), a touch screen, a tactile output device, a printer and/or speakers). The interface circuit 720 of the illustrated example, thus, typically includes a graphics driver card, a graphics driver chip or a graphics driver processor.

The interface circuit 720 of the illustrated example also includes a communication device such as a transmitter, a receiver, a transceiver, a modem and/or network interface card to facilitate exchange of data with external machines (e.g., computing devices of any kind) via a network 726 (e.g., an Ethernet connection, a digital subscriber line (DSL), a telephone line, coaxial cable, a cellular telephone system, etc.).

The consumer electronics device 700 of the illustrated example also includes one or more mass storage devices 728 for storing software and/or data. In some examples, the example real-time database 402 of FIG. 4 is implemented via the example one more mass storage devices 728 of FIG. 7. Examples of such mass storage devices 728 include floppy disk drives, hard drive disks, compact disk drives, Blu-ray disk drives, RAID systems, and digital versatile disk (DVD) drives.

Coded instructions 732 of FIGS. 5 and/or 6 may be stored in the mass storage device 728, in the volatile memory 714, in the non-volatile memory 716, and/or on a removable tangible computer readable storage medium such as a CD or DVD.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus, comprising:
memory to store a media identifier corresponding to media designated for real-time reporting;
a detector to obtain media identifying information from a presentation generated by a media presentation device at a presentation time; and
a reporter to:
when (1) the obtained media identifying information corresponds to the stored media identifier and (2) the presentation time indicates that the presentation is live, convey a detection indication to a collection facility without delay; and
when (1) the obtained media identifying information does not correspond to the stored media identifier or (2) the presentation time indicates that the presentation is not live, designate the detection indication for a delayed conveyance to the collection facility.

2. An apparatus as defined in claim 1, further comprising a comparator to determine whether the presentation time indicates that the presentation is live by comparing the presentation time to live time data associated with the obtained media identifying information.

3. An apparatus as defined in claim 2, wherein the presentation is live when the presentation time is within a threshold amount of time of a delivery time indicated by the live time data.

4. An apparatus as defined in claim 2, wherein the live time data is representative of a broadcast time associated with the obtained media identifying information.

5. An apparatus as defined in claim 1, wherein the media identifying information is first media identifying information, and the reporter is to perform the delayed conveyance to the collection facility by:
storing the media identifying information;
generating a batch of data including the first media identifying information and second media identifying information; and
conveying the batch at a predetermined time.

6. An apparatus as defined in claim 1, wherein the reporter is to convey the detection indication to the collection facility without delay by transmitting the media identifying information to the collection facility in real-time.

7. An apparatus as defined in claim 1, wherein the collection facility comprises a server associated with a media measurement entity.

8. A method, comprising:
storing a media identifier corresponding to a piece of media designated for real-time reporting;
monitoring, via a processor, a presentation device to determine whether the piece of media is being presented by the presentation device;
when the piece of media is detected as being presented live by the presentation device, reporting, via the processor, detection of the piece of media without delay; and
when the piece of media is detected as not being presented live by the presentation device, reporting, via the processor, the detection of the piece of media with delay.

9. A method as defined in claim 8, further comprising determining whether the piece of media is being presented live by comparing a presentation time associated with the detection to live time data indicative of a delivery time associated with the piece of media.

10. A method as defined in claim 8, wherein the piece of media being presented live by the presentation device comprises the presentation device presenting the piece of media at a substantially similar time as the piece of media being provided to the presentation device.

11. A method as defined in claim 8, wherein the piece of media being presented live by the presentation device comprises the presentation device presenting the piece of media at a substantially similar time as a broadcast time of the piece of media.

12. A method as defined in claim 8, wherein reporting the detection of the piece of media with delay comprises batching the detection with a second detection and conveying batched data at a predetermined time.

13. A method as defined in claim 8, wherein reporting the detection without delay comprises transmitting the detection to a collection facility in real-time.

14. A tangible computer readable storage medium comprising instructions that, when executed, cause a consumer electronics device to at least:
store a plurality of media identifiers corresponding to respective media designated for real-time reporting;
extract media identifying information from media generated by a presentation device, the media identifying information including:
a detected media identifier; and
live time data indicative of a first time at which the media was provided to the presentation device; and
when the detected media identifier corresponds to one of the stored plurality of media identifiers:
use the live time data to determine whether the media is being presented live by the presentation device;
report detection of the media without delay when the media is being presented live by the presentation device; and
report detection of the media with delay when the media is not being presented live by the presentation device.

15. A storage medium as defined in claim 14, wherein the instructions, when executed, cause the consumer electronics device to, when the detected media identifier does not correspond to one of the stored plurality of media identifiers, report the detection of the media with delay.

16. A storage medium as defined in claim 14, wherein the instructions, when executed, cause the consumer electronics device to use the live time data to determine whether the media is being presented live by comparing the live time data to a presentation time stamp.

17. A storage medium as defined in claim 14, wherein the instructions, when executed, cause the consumer electronics device to report the detection of the media with delay by storing the detection of the media in memory and scheduling a transmission of the detection of the media for a predetermined time.

18. A storage medium as defined in claim 17, wherein the instructions, when executed, cause the consumer electronics device to schedule the transmission of the detection of the media for the predetermined time based on at least one of network costs at different times of day, expected network traffic at different times of day, or expected activity levels associated with the consumer electronics device.

19. A storage medium as defined in claim 14, wherein the instructions, when executed, cause the machine to report the detection of the media in real-time by transmitting the detection of the media at a substantially similar time as a broadcast time of the media.

20. A storage medium as defined in claim 14, wherein the instructions, when executed cause the machine to report the detection of the media by transmitting a data package to a collection facility, the data package including the detected media identifier.
